(19) United States
(12) Patent Application Publication
(10) Pub. No.: US 2007/0038805 A1
(43) Pub. Date: Feb. 15, 2007

(54) High granularity redundancy for ferroelectric memories

(75) Inventors: Jarrod Randall Eliason, Colorado Springs, CO (US); Sudhir Kumar Madan, Richardson, TX (US); Sung-Wei Lin, Plano, TX (US); Hugh P. McAdams, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/200,390

(22) Filed: Aug. 9, 2005

(51) Int. Cl. G06F 12/00

(52) U.S. Cl. 711/107

(57) ABSTRACT

A scheme for dealing with or handling faulty ‘grains’ or portions of a nonvolatile ferroelectric memory array is disclosed. In one example, a grain of the memory is less than a column high and less than a row wide. A replacement operation is performed on the memory portion when a repair programming group finds that an address of the portion corresponds to a failed row address and a failed column address.

### FIELD OF INVENTION

The present invention relates generally to semiconductor devices and more particularly to addressing faults in nonvolatile ferroelectric memory with redundancy techniques.

### BACKGROUND OF THE INVENTION

Ferroelectric memory and other types of semiconductor memory are used for storing data and/or program code in personal computer systems, embedded processor-based systems, and the like. Ferroelectric memory commonly includes groups of memory cells, wherein the respective memory cells comprise single-transistor, single-capacitor (1T1C) or two-transistor, two-capacitor (2T2C) arrangements, in which data is read from or written to the memory using address signals and/or various other control signals. Ferroelectric memory cells include at least one transistor and at least one capacitor because the ferroelectric capacitors serve to store a binary bit of data (e.g., a 0 or 1), and the transistors facilitate accessing that data.

Ferroelectric memory is said to be nonvolatile because data is not lost when power is disconnected there-from. Ferroelectric memory is nonvolatile because the capacitors within the cells are constructed utilizing a ferroelectric material for a dielectric layer of the capacitors. The ferroelectric material may be polarized in one of two directions or states to store a binary value. This is at times referred to as the ferroelectric effect, wherein the retention of a stable polarization state is due to the alignment of internal dipoles within Perovskite crystals that make up the dielectric material. This alignment may be selectively achieved by applying an electric field to the ferroelectric capacitor in excess of a coercive field of the material. Conversely, reversal of the applied electric field reverses the internal dipoles. The polarization of a ferroelectric capacitor to an applied voltage may be plotted as a hysteresis curve.

As in most modern electronics, there is an ongoing effort in ferroelectric memories to shrink the size of component parts and/or to otherwise conserve space so that more elements can be packed onto the same or a smaller area, while concurrently allowing increasingly complex functions to be performed. Increasing the number of cells in a memory array, however, also increases the opportunity for cell failures. Accordingly, a technique would be desirable that provides high repair probability for a ferroelectric memory array in an area efficient manner. A high repair probability maximizes yield, and area efficient circuitry minimizes die cost. Both of these effects lead to reduced cost per bit, which is a critical metric for integrated circuit memories.

### SUMMARY OF THE INVENTION

The following presents a simplified summary of the invention in order to provide a basic understanding of some aspects of the invention. This summary is not an extensive overview of the invention. It is intended neither to identify key or critical elements of the invention nor to delineate the scope of the invention. Rather, its primary purpose is merely to present one or more concepts of the invention in a simplified form as a prelude to the more detailed description that is presented later.

The present invention pertains to handling defective portions or ‘grains’ of a nonvolatile ferroelectric memory array. Failed portions of the memory array are replaced in an area efficient manner so that valuable semiconductor real estate is not wasted. This is particularly useful as the density of memory arrays increases.

According to one or more aspects of the present invention, a method of handling a faulty portion or grain of a nonvolatile ferroelectric memory array is disclosed. The method includes performing a replacement operation on the nonvolatile ferroelectric memory portion when an address of the portion corresponds to faulty row and faulty column information, and where the portion is less than a column high and a row wide.

To the accomplishment of the foregoing and related ends, the following description and annexed drawings set forth and detail certain illustrative aspects and implementations of the invention. These are indicative of but a few of the various ways in which one or more aspects of the present invention may be employed. Other aspects, advantages and novel features of the invention will become apparent from the following detailed description of the invention when considered in conjunction with the annexed drawings.

### BRIEF DESCRIPTION OF THE DRAWINGS

FIG. 1 is a schematic block diagram of at least a portion of an exemplary nonvolatile ferroelectric memory array according to one or more aspects of the present invention.

FIG. 2 illustrates certain actions performed in a scheme for effecting row redundancy according to one or more aspects of the present invention.

FIG. 3 is a schematic block diagram of an exemplary scheme for effecting row redundancy in accordance with one or more aspects of the present invention, where such an exemplary scheme can implement the actions set forth in FIG. 2.

FIG. 4 is a block diagram illustrating a high level view of a nonvolatile ferroelectric memory array in accordance with one or more aspects of the present invention.

FIG. 5 is a block diagram illustrating details of a data path according to one or more aspects of the present invention.

FIG. 6 is a schematic diagram illustrating a data shift in accordance with one or more aspects of the present invention.

FIG. 7 is a schematic block diagram of an exemplary scheme for a column redundancy implementation in accordance with one or more aspects of the present invention.

FIG. 8 is a schematic block diagram of an exemplary scheme for a row redundancy implementation in accordance with one or more aspects of the present invention.

FIG. 9 is a schematic block diagram of an exemplary scheme for a high granularity implementation in accordance with one or more aspects of the present invention.

### DETAILED DESCRIPTION OF THE INVENTION

The present invention pertains to handling faulty portions of a nonvolatile ferroelectric memory array. One or more aspects of the present invention will now be described with reference to drawing figures, wherein like reference numerals are used to refer to like elements throughout. It should be understood that the drawing figures and following descriptions are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details. Thus, it will be appreciated that variations of the illustrated systems and methods apart from those illustrated and described herein may exist and that such variations are deemed as falling within the scope of the present invention and the appended claims.

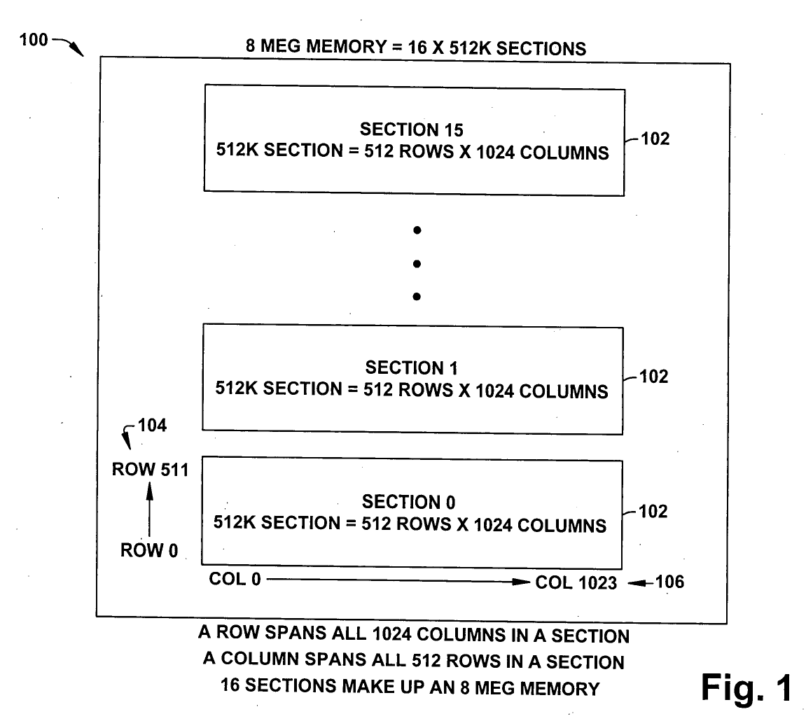

Turning to FIG. 1, a schematic block diagram illustrates at least some of an exemplary memory array according to one or more aspects of the present invention. In the illustrated example, eight meg of memory 100 is presented, where a full compliment of the array may comprise a 64 megabit memory, for example, that includes eight of such eight meg portions. In any event, the eight megabit memory 100 presented comprises sixteen 512 kilobit sections 102 (section 0 thru section 15). Each of the 512 kilobit sections 102 comprises 512 rows 104 (row 0 thru row 511) and 1024 columns 106 (column 0 thru column 1023).

It will be appreciated that, in accordance with one or more aspects of the present invention, one spare column (not shown) is allocated per data word width. The 1024 columns can be divided into 64 data word widths of 16 columns each. Providing one spare column per data word width results in 64 redundant columns (not shown) being interspersed among the 1024 columns. It will also be appreciated that, according to one or more aspects of the present invention, information pertaining to a section address and row within the section is relevant to a row redundancy implementation. Similarly, information pertaining to a section address and column within the section is relevant to column redundancy and high granularity redundancy implementations. Further, it will be appreciated that a section of the memory array may be subdivided into 16 32 kbit segments each comprised of 64 columns, and such a configuration may subsequently be discussed when referencing later Figures.

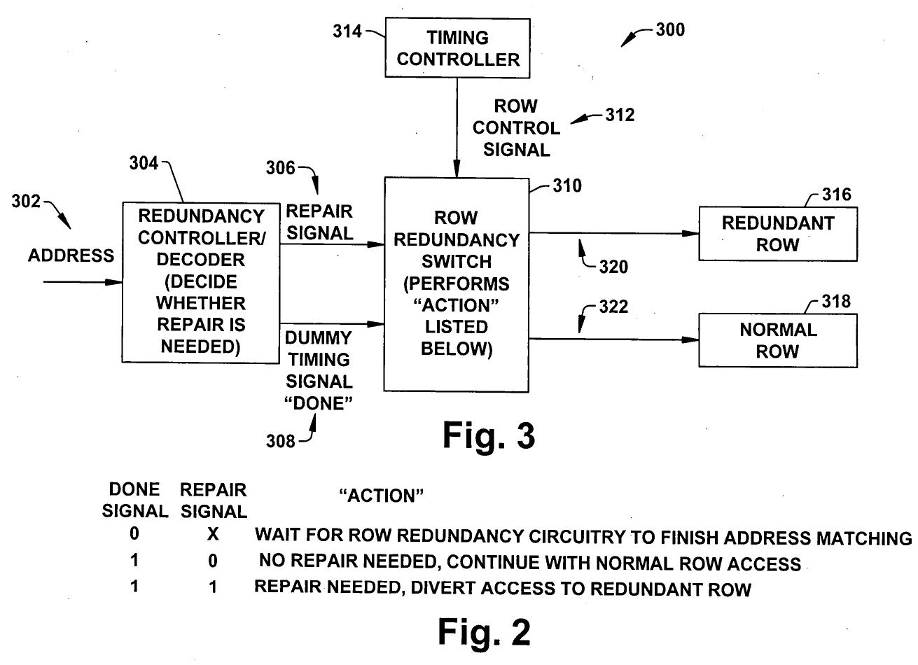

FIG. 2 illustrates certain actions performed in a scheme for effecting row redundancy in accordance with one or more aspects of the present invention, and more particularly actions taken by a redundancy switch component in such a scheme. FIG. 3 illustrates an exemplary scheme 300 for effecting row redundancy in accordance with one or more aspects of the present invention. The address 302 of a row (including its section address) of a nonvolatile ferroelectric memory array which is to be acted upon (e.g., accessed for a read/write operation) is input into a redundancy controller/decoder component 304. The redundancy controller/decoder component 304 determines whether a repair is needed, such as by comparing the address 302 to a database and/or list of known bad addresses, for example, comprised within the redundancy controller/decoder component 304. The redundancy controller/decoder component 304 outputs a repair signal 306 and a dummy timing signal 308 which may also be referred to as a ‘done’ signal. This done signal when enabled indicates that the circuit had enough time to decide whether one or more repairs are needed. The repair signal 306 and the done signal 308 are input into a row redundancy switch component 310. Similarly, a row control signal 312 that is generated by a timing controller component 314 is also input into the row redundancy switch component 310.

The row redundancy switch component 310 performs the actions set forth in FIG. 2 based upon the signals 306, 308. More particularly, when the dummy timing signal 308 is low or not yet ‘done’, the row redundancy switch component 310 merely waits for this signal to time out. This allows the redundancy circuitry in the redundancy controller/decoder component 304 to finish address matching, among other things. The repair signal 306 is generally ignored while the timing signal 308 is timing. Once the timing signal 308 has timed out and thus is a logic high or “1”, the row redundancy switch component 310 consults the repair signal 306 to determine whether the address should be accessed from a redundant row 316 or from a normal row 318. In particular, the row redundancy switch component 310 outputs a redundant row signal 320 directing that access be diverted to a redundant row 316 when the repair signal is high or a logic one, indicating that a repair is warranted. Alternatively, the row redundancy switch component 310 outputs a normal row signal 322 directing that access to proceed as normal to a normal row 316 of the array when the repair signal 306 is low or a logic zero, indicating that no repair is needed.

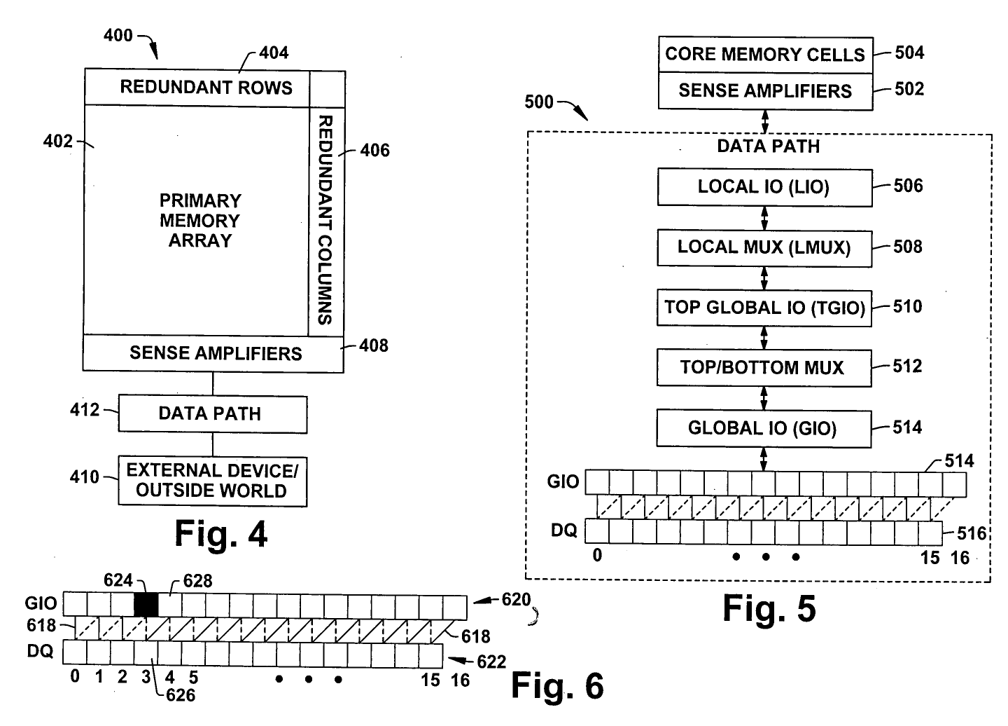

FIG. 4 is a block diagram illustrating a relatively high level view of a segment of a nonvolatile ferroelectric memory 400 according to one or more aspects of the present invention. The memory segment 400 comprises a centralized primary memory array portion 402 surrounded by more peripheral portions. In particular, in the illustrated example the primary memory array portion 402 is adjoined by a set of redundant rows 404, a set of redundant columns 406 and one or more sense amplifiers 408. In practice the redundant rows and columns may be distributed throughout the primary memory array. The sense amplifiers 408 generally provide for interaction with the array, such as to effect read/write operations, for example, via bitlines, wordlines, etc. The memory segment 400 interfaces with the outside world/external devices 410 via a data path 412, through which data is passed to and from the array.

FIG. 5 schematically illustrates in somewhat greater detail a data path 500 according to one or more aspects of the present invention. The data path 500 is in an operative coupling/communication relationship with one or more sense amplifiers 502, which are in turn operatively coupled to core memory cells 504. The data path 500 comprises a local input output component (LIO) 506 at a lower level next to the sense amplifiers 502 and memory cells 504. The local input output component 506 is operatively coupled to a local multiplexer component (LMUX) 508, which is in turn operatively coupled to a top global input output component (TGIO) 510. The top global input output component 510 is operatively coupled to a top/bottom multiplexer component 512, and the top/bottom multiplexer component 512 is operatively coupled to a global input output component 514 (GIO). The global input output component 514 is situated at a higher end of the data path closer to external circuitry, such as external DQ latching circuitry 516, for example. The illustrated example may provide for column type shifting and/or a higher granularity type shifting in accordance with one or more aspects of the present invention, where a ‘grain’ of a memory area is less than a column high and less than a row wide.

It will be appreciated that a shifting or replacement operation can occur between the global input output component 514 and external DQ circuitry 516 according to one or more aspects of the present invention. This is illustrated in FIG. 6, wherein an exemplary shift is occurring at GIO <3>. More particularly, solid lines 618 indicate data transfer between GIO blocks 620 and DQ blocks 622. In the illustrated example, data is transferred between respective GIO blocks 620 and DQ blocks 622 for the first three blocks (0 thru 2). However, the fourth GIO block GIO <3> 624 is blacked out indicating a defective column or grain currently connected to GIO <3>. Accordingly, a shift or replacement operation is implemented at this point such that subsequent data transfers occur between the DQ blocks 622 and the incremental next GIO blocks 620. For example, data is then transferred between the fourth DQ block DQ <3> 626 and the fifth GIO block GIO <4> 628.

It will be appreciated that D is used as an input and Q is used as an output in the exemplary DQ blocks 622. In this example, the DQ's thus do not correspond to a latch, but are more synonymous with IO's. ‘DQ’ is merely used to specify that this is at the outside of the chip and at the very outside of the data path. Accordingly, communications between the chip and other parts of the system or other chips occur via the DQ. As mentioned above with regard to describing FIG. 1, one spare column can be allocated per data word width in accordance with one or more aspects of the present invention, where data words can be 16 columns wide. This is illustrated in FIGS. 5 and 6 where 17 blocks are depicted (GIO <0> thru GIO <16>), such that one of the blocks corresponds to a redundant or spare column. It will be appreciated that the number of redundant columns per word needed will depend upon the number of columns per grain. If a grain is for example 2 columns wide and 2 rows high, then 2 redundant columns per word may be needed to implement the redundancy and the shifting of columns between GIO 620 and DQ 622 will be adjusted accordingly. Similar consideration will apply while replacing more than one redundant column per word.

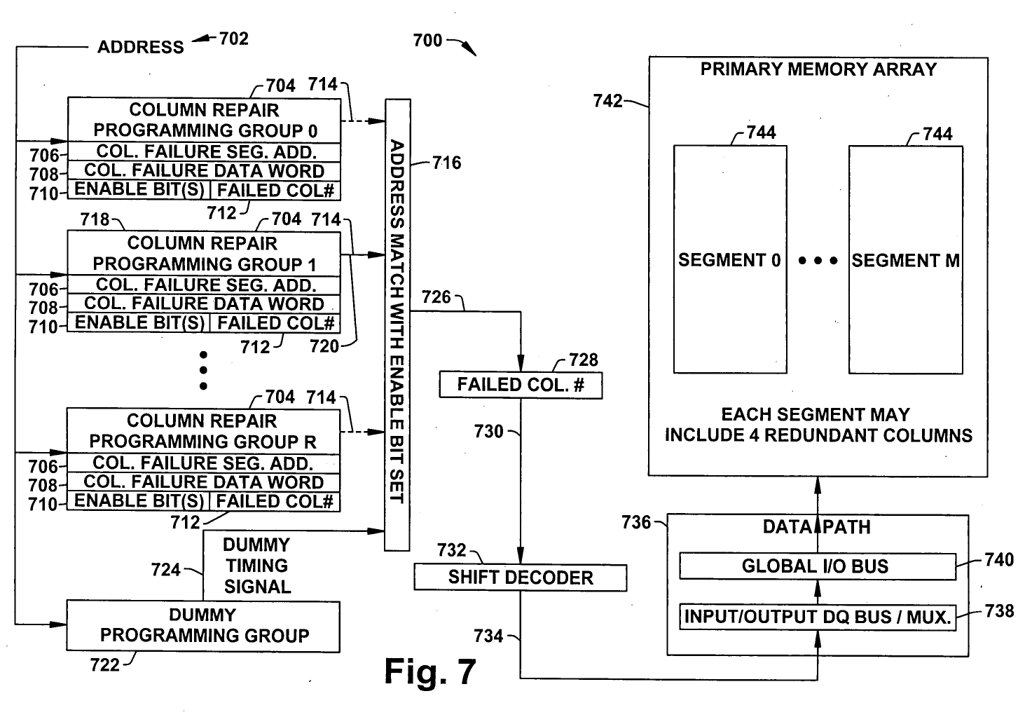

Turning to FIG. 7, a scheme 700 is illustrated in block diagram form that is operable to implement column redundancy in accordance with one or more aspects of the present invention. The address 702 of a column of a nonvolatile ferroelectric memory array which is to be acted upon (e.g., accessed for a read/write operation) is fed into a plurality of column repair programming group components 704. In the illustrated example, 0 through R column repair programming group components are depicted, R being a positive integer. The column repair programming group components 704 comprise respective column failure segment address aspects 706, column failure data word aspects 708, enable bit(s) 710 and failed column numbers 712. The column repair programming group components 704 are operable to output respective signals 714 to an address match with enable bit set component 716. In the illustrated example, the second column repair programming group component (group 1) 718 is depicted as sending a signal 720 to the address match with enable bit set component 716. This is generally indicative of the second column repair programming group component 718 identifying or recognizing the address as corresponding to a bad or faulty column of the memory.

The address 702 is also fed into a dummy programming group 722, which outputs a dummy timing signal 724 to the address match with enable bit set component 716. The address match with enable bit set component 716 outputs signals 726 to a failed column number component 728. The failed column number component 728 outputs signals 730 to a shift decoder component 732, which in turn outputs signals 734 to a data path 736. It will be appreciated that the signal 734 from the shift decoder component 732 generally comprises shift (or no shift) commands. As described above with regard to FIGS. 5 & 6, shifting can occur at a higher level in accordance with one or more aspects of the present invention. Accordingly, higher level components of an input/output DQ bus/multiplexer 738 and a global input/output bus 740 are illustrated in the data path 736 depicted in FIG. 7, whereby any such necessary shifting can be performed in these components 738, 740 in accordance with the signal 734 from the shift decoder component 732 according to one or more aspects of the present invention.

The data path 736 is operatively coupled to the primary memory array 742, such as via sense amplifiers, bitlines, wordlines, etc., for example, (not shown). In the illustrated example, the primary memory array 742 includes 0 through M segments 744, where M is a positive integer. For example, as depicted in FIG. 2, there may be 256 segments 744 within the array 742. It will be appreciated that each of the segments 744 may comprise 32 kilobits and four redundant columns in accordance with one or more aspects of the present invention. It will also be appreciated that the address match with enable bit set component 716 and the failed column number component 728 may not be physical components, but may instead correspond to one or more signals. For example, when a column repair programming group component 704 finds a ‘match’ or identifies the address 702 as corresponding to a bad or defective memory portion and there is also an enable bit that is ‘set’ (e.g., a logic high), that column repair programming component may output signals corresponding to component 716. Similarly, these signals, or a portion thereof, may be advanced to the shift decoder component 732 as the failed column number component 728 after the timing signal 724 times out. Alternatively, the relevant column repair programming group component can output a signal corresponding to component 728 after the timing signal 724 times out (and an address match has been found along with a set enable bit). Further, it is to be appreciated that bad or failed addresses may be loaded from nonvolatile (configuration data) cells to volatile registers by a configuration load controller component (not shown).

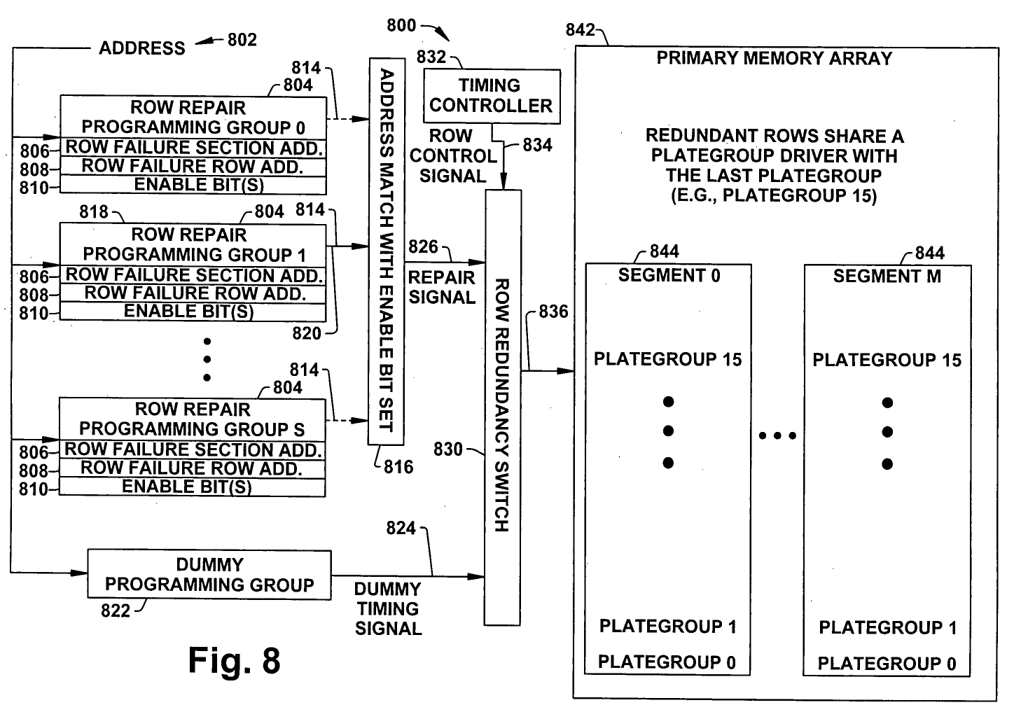

Turning to FIG. 8, a scheme 800 is illustrated in block diagram form that is operable to implement row redundancy in accordance with one or more aspects of the present invention. The address 802 of a row of a nonvolatile ferroelectric memory array which is to be acted upon (e.g., accessed for a read/write operation) is fed into a plurality of row repair programming group components 804. In the illustrated example, 0 through S row repair programming group components are depicted, S being a positive integer. The row repair programming group components 804 comprise respective row failure section address aspects 806, row failure row address aspects 808 and enable bit(s) 810. The row repair programming group components 804 are operable to output respective signals 814 to an address match with enable bit set component 816. In the illustrated example, the second row repair programming group component (group 1) 818 is depicted as sending a signal 820 to the address match with enable bit set component 816. This is generally indicative of the second row repair programming group component 818 identifying or recognizing the address as corresponding to a bad or faulty row of the memory.

The address 802 is also fed into a dummy programming group 822, which outputs a dummy timing signal 824 to a row redundancy switch component 830. The address match with enable bit set component 816 similarly outputs a repair signal 826 to the row redundancy switch component 830. A timing controller component 832 also outputs a row control signal 834 to the row redundancy switch component 830. The row redundancy switch component 830 outputs signals 836 to a primary memory array 842 in response to signals 824, 826 and 834. The signals 836 generally indicate whether normal or redundant rows are to be accessed in the memory array 842. It can be appreciated that the left, middle and right portions of FIG. 8 generally correspond to the left, middle and right portions of FIG. 3, respectively.

In the illustrated example, the primary memory array 842 includes 0 through M segments 844, where M is a positive integer. The respective segments 844 include 16 plategroups (0-15). In this arrangement, redundant rows can share a plategroup driver with the last plategroup (e.g., plategroup 15). It will be appreciated that FRAM's have conventionally not used a plategroup driver. Instead, they have used individual plate drivers. Since the FRAM's herein have a plategroup driver, the redundant wordlines herein share a plategroup driver with the last plategroup. So, the last plategroup, instead of having 32 wordlines on the plategroup, has 38 wordlines—4 for redundancy and 2 for configuration data.

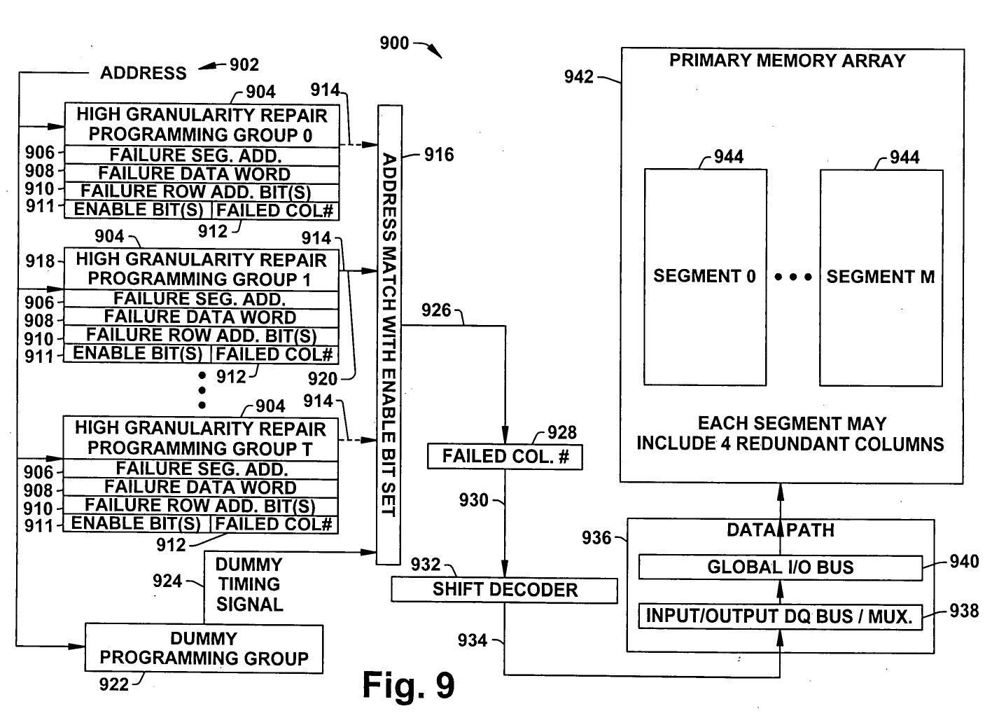

FIG. 9 illustrates a scheme 900 in block diagram form that is operable to effect a high granularity redundancy implementation in accordance with one or more aspects of the present invention. The address 902 of a portion or ‘grain’ of a nonvolatile ferroelectric memory array which is to be acted upon (e.g., accessed for a read/write operation) is fed into a plurality of high granularity repair programming group components 904. In this context a ‘grain’ is defined as a portion of memory less than a column high and less than a row wide. In the illustrated example, 0 through T high granularity repair programming group components are depicted, T being a positive integer. The high granularity repair programming group components 904 comprise respective failure segment address aspects 906, failure data word aspects 908, failure row address bit(s) 910, enable bit(s) 911 and failed column number bit(s) 912. The high granularity repair programming group components 904 are operable to output respective signals 914 to an address match with enable bit set component 916. In the illustrated example, the second high granularity repair programming group component (group 1) 918 is depicted as sending a signal 920 to the address match with enable bit set component 916. This is generally indicative of the second high granularity repair programming group component 918 identifying or recognizing the address as corresponding to a bad or faulty portion or ‘grain’ of the memory.

The address 902 is also fed into a dummy programming group 922, which outputs a dummy timing signal 924 to the address match with enable bit set component 916. The address match with enable bit set component 916 outputs signals 926 to a failed column number component 928. The failed column number component 928 outputs signals 930 to a shift decoder component 932, which in turn outputs signals 934 to a data path 936. It will be appreciated that the signals 934 from the shift decoder component 932 generally comprises shift (or no shift) commands. As described above with regard to FIGS. 5, 6 & 7, shifting can occur at a higher level in accordance with one or more aspects of the present invention. Accordingly, higher level components of an input/output DQ bus/multiplexer 938 and a global input/output bus 940 are illustrated in the data path 936 depicted in FIG. 9, whereby any such necessary shifting can be performed in these components 938, 940 in accordance with the signal 934 from the shift decoder component 932 according to one or more aspects of the present invention.

The data path 936 is operatively coupled to the primary memory array 942, such as via sense amplifiers, bitlines, wordlines, etc., for example, (not shown). In the illustrated example, the primary memory array 942 includes 0 through M segments 944, where M is a positive integer. For example, as depicted in FIG. 2, there may be 256 segments 944 within the array 942. It will be appreciated that each of the segments 944 may comprise 32 kilobits and four redundant columns in accordance with one or more aspects of the present invention. It will also be appreciated that the address match with enable bit set component 916 and the failed column number component 928 may not be physical components, but may instead correspond to one or more signals. For example, when a high granularity repair programming group component 904 finds a ‘match’ or identifies the address 902 as corresponding to a bad or defective memory portion and there is also an enable bit that is ‘set’ (e.g., a logic high), that high granularity repair programming component may output signals corresponding to component 916. Similarly, these signals, or a portion thereof, may be advanced to the shift decoder component 932 as the failed column number component 928 after the timing signal 924 times out. Alternatively, the relevant high granularity repair programming group component can output a signal corresponding to component 928 after the timing signal 924 times out (and an address match has been found along with a set enable bit). Further, it is to be appreciated that bad or failed addresses may be loaded from nonvolatile (configuration data) cells to volatile registers by a configuration load controller component (not shown).

It will be appreciated that one or more features facilitated by one or more aspects of the present invention include 1T1C 8 megabit ferroelectric random access memory with 0.71 square micrometer cell operating at 1.5V on a 130 nanometer 5 LM Cu process.

It will also be appreciated that, in accordance with one or more aspects of the present invention, respective row repairs may replace two rows to maintain compatibility with 2T2C operation. Respective sections share row repair programming resources. In one example merely 16 of 32 possible row repairs may be supported to reduce required register area, reduce power consumption and improve the circuit speed by limiting the number of registers. Four redundant columns can reside in respective segments with one redundant column dedicated to a group of 16 columns in the same data word. Respective segments share column repair programming resources. A configuration area can, for example, include a sufficient number of column repair registers to implement 32 of 1024 redundant columns to reduce the required register area. Additional repairs can be performed on individual bit pairs where the repair element is merely 2 bits. The same redundant columns may be used for either column repair or single grain repair. These numbers are generally valid for an 8 Meg memory made up of 256 segments with a total of 4 redundant columns per segment for a total of 1024 redundant columns. The high granularity redundancy generally replaces two bits at a time, thereby increasing the repair granularity (as compared to column redundancy) by 256x to 262,144 repair elements. Row repairs generally happen two rows at a time, so there are merely 32 row repair elements even though there are 64 redundant rows.

By way of further example, a discussion follows that pertains to redundancy in making memory repairs. The discussion illustrates some of the benefits of making repairs according to one or more aspects of the present invention, particularly in terms of probability and cost benefit analysis.

Existing redundancy techniques typically use a fixed register mapping approach (which can be static) to conserve register space per repair and the shifting or replacement of columns is done at a lower level such as sense amplifiers at the time of power-up. The preferred embodiment of this invention, however, utilizes dynamic register mapping. Although dynamic register mapping requires more register bits per repair, the following discussion demonstrates how dynamic register mapping actually reduces the total number of register bits required and furthermore enables high granularity repairs at a minimal repair register cost.

Fixed Register Mapping:

In the fixed register mapping approach, repair programming registers are permanently associated with a given area of the memory. For example, each segment of memory could have repair programming registers for a column repair. If there are 64 columns in a segment and 1 redundant column per segment, then only 7 repair programming register bits per segment (including enable bit) are needed to implement a column repair. In an 8 Meg memory with 256 segments, the entire column redundancy programming register space would require 1,792 bits.

Dynamic IO matching must take place between current column address and the programmed failing column address for the current segment, but dedicating repair programming registers to a segment results in 1) a small number of repair programming register bits per repair and 2) the ability to use all the available repair elements.

Dynamic Register Mapping:

In the dynamic register mapping approach utilized according to one or more aspects of the present invention, repair programming registers are not committed to any given area of the memory. Using the previous example of 256 segments each having 64 columns and 1 redundant column, a total of 15 bits is required to implement 1 repair—over twice as many register bits per repair compared to the fixed register mapping case. Consequently, providing enough repair programming registers for all 256 segments would require 3,840 bits. This appears to be a significant disadvantage compared to fixed register mapping. However, a simple understanding of statistics reveals that it is unnecessary to provide repair programming registers for all 256 segments.

In the example memory consisting of 256 segments, each with 64 columns and 1 redundant column, the statistics for random defects are easily calculated. Since only 1 column can be repaired per segment, a 2^{nd} failure occurring in the same segment will not be repairable. For the sake of these calculations, two defects occurring in the same column are taken to be a single failure.

The 1st column failure on a chip will always be repairable. A 2^{nd} random column failure will have a 255/256 chance of repair since there is a 1/256 chance the 2^{nd} failure will overlap with the 1^{st} failure. A 3^{rd} random column failure will have a 254/256 chance of repair since there is a 2/256 chance that the 3^{rd} failure will overlap one of the first two. A die with 3 random column failures will have 98.8% chance of repair as calculated below.
256/256×255/256×254/256=98.8% (1^{st} fail) (2^{nd} fail) (3^{rd} fail)

The probability of repair for any number of random column failures is similarly calculated and graphed below.

[image]

As can be seen in the graph above, there is no practical chance of repairing more than 50 random column failures. Consequently, 50 dynamically mapped registers (750 bits) would provide the same repair capability as 256 fixed registers (1,792 bits). The benefit of dynamic register mapping is clear.

Repair Granularity:

Examination of the repair probability statistics shows the repair probability to be dominated by the number of repair elements. Changing the redundancy design to provide 1 redundant column per 16 significantly improves the repair probability for a given number of failures by increasing the number of repair elements to 1,024. For example, 20 failures has less than 50% repair probability in the 1 of 64 case graphed above, while a 1 of 16 design maintains over 80% chance of repair for 20 failures.

Further improvement in repair probability is possible for defects that do not affect an entire column. If single bit failures dominate over other defect categories the number of repair elements can be increased by dividing a single redundant column into several smaller repair grains. This can be accomplished by using bits from a redundant column only when one or more row addresses also match. A further advantage of such high granularity repair is that it can use the same redundant columns as column repair as long as the redundancy algorithm has sufficient intelligence to avoid overlapping repairs.

An increase in repair capability typically requires added circuit area. Moving from 1 in 64 column repair to 1 in 16 column repair quadruples the number of spare columns on the chip, although no extra register space is needed. Adding row address qualifiers for high granularity repair does not require any new redundant columns, but each supported repair adds programming register area that depends on the number of rows in each redundant grain. Since a primary goal of redundancy is to improve yield and consequently minimize cost per die, increases in circuit area work against the goal of minimum die cost. The trade-off between repair probability and die area can be quantified for a given redundancy approach. The graph below plots a normalized number of repairable 8 Meg die per wafer as a function of failures for 3 redundancy approaches. These are 1) column repair only with 1 redundant column per 64 columns, 2) column repair only with 1 redundant column per 16 columns and 3) high granularity repair with 1 redundant column per 16 columns and a grain height of 2 bits (i.e. 1 repair per 32 bits).

[image]

The graph above illustrates the benefits of increased repair granularity for higher numbers of failures per die. For low failure counts, low granularity redundancy is sufficient and causes the least area impact. However, as explained previously, the low granularity column redundancy is not able to effectively handle even 50 single bit failures out of 8 million bits. Quadrupling the column redundancy granularity offers some improvement, but 50 bit failures would still result in unacceptably low yield. Increasing the repair granularity to 1 repair per 32 bits (2 rows×16 columns) improves the repair probability for 50 bit failures to 99.5%. The programming register area required to store these 50 repairs and perform address matching increases the area of the chip by 2% such that the estimated normalized yield falls to 97.5%. The estimated area adder as a function of supported repairs is plotted below for the 1 in 32 bit repair case.

[image]

Ideally the decision regarding the number of repairs to support should be guided by process data. However, in the case of a new or changing process, selecting the number of repairs to support is a matter of engineering trade-offs. Although supporting 1,000 repairs only adds about 8% to the die area, the probability of repairing 1,000 bits is less than 15%. Clearly this many bit failures would result in poor yields, and the product would not be economically viable. As the process improved, die with a low failure count would carry the extra 8% redundancy area without any benefit. At the other extreme, arbitrarily limiting the register area to only 50 repairs is unreasonable since doubling the repair capability would only add 0.3% to the chip area.

In the 8 Meg memory example, 128 high granularity repairs are supported with 97% repair probability and circuit area adder of ˜2.5%. 32 column repairs (1 of 16) are also supported to repair defects which affect an entire column. It can be appreciated that column redundancy and high granularity redundancy as disclosed herein share common redundant columns in order to minimize the redundancy circuit area.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, sub-circuits, sub-systems etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising.” Also, the term “exemplary” as used herein is merely meant to mean an example, rather than the best. Likewise, the terms faulty, failed, etc. are intended to include any type of memory cell that does not function (as reliably) as desired. The term signal may signify a signal or plurality of signals or a signal bus or plurality of signal buses. Moreover, a signal or data may refer to a data line or plurality of data lines or a data bus or plurality of data buses.0

What is claimed is:

1. A method of handling a faulty portion or grain of a nonvolatile ferroelectric memory array, comprising:
performing a replacement operation on the nonvolatile ferroelectric memory portion when an address of the portion corresponds to faulty row and faulty column information, and where the portion is less than a column high and a row wide.

2. The method of claim 1, wherein the replacement operation comprises a shifting operation performed on a shared input/output (IO) signal.

3. The method of claim 1, wherein the replacement operation is performed at a high level in a data path hierarchy of the nonvolatile ferroelectric memory.

4. The method of claim 3, wherein the replacement operation is performed between external DQ logic and global input/output (GIO) circuitry.

5. The method of claim 1, wherein the replaced memory portion (grain) size is bound on a lower end to a single bit.

6. The method of claim 1, wherein 2 bits are replaced at a time.

7. The method of claim 1, wherein repair programming registers are fewer in number than available repair elements.

8. The method of claim 1, further comprising:
loading failed addresses from ferroelectric nonvolatile memory into volatile repair programming registers at power up.

9. The method of claim 1, wherein a replacement operation is performed when an address match occurs within a repair programming group and an enable bit is set.

10. A method of performing a row redundancy technique for a nonvolatile ferroelectric memory array, comprising:
performing a replacement operation on a faulty aspect of a row of a nonvolatile ferroelectric memory array, where the replacement operation is performed with one or more redundant rows of the nonvolatile ferroelectric memory array, and where the one or more redundant rows share common programming registers.

11. The method of claim 10, wherein row repair programming registers are fewer in number than available repair elements.

12. The method of claim 10, wherein redundant rows share a plategroup with the primary nonvolatile ferroelectric memory array.

13. The method of claim 10, wherein 2 rows are repaired at a time.

14. A method of performing a column redundancy technique for a nonvolatile ferroelectric memory array, comprising:
performing a replacement operation on a faulty aspect of a column of a nonvolatile ferroelectric memory array, where the replacement operation is performed with one or more redundant columns of the nonvolatile ferroelectric memory array, and where the replacement operation comprises a shifting operation performed on a shared input/output (IO) signal of the nonvolatile ferroelectric memory array.

15. The method of claim 14, wherein the one or more redundant columns share common programming registers.

16. The method of claim 14, wherein the replacement operation is performed at a high level in a data path hierarchy of the nonvolatile ferroelectric memory.

17. The method of claim 16, wherein the replacement operation is performed between external (DQ) latching logic and global input/output (GIO) circuitry.

18. A system configured to perform a row redundancy technique for a nonvolatile ferroelectric memory array, comprising:
a plurality of row repair programming group components operative to receive address information regarding an address of the nonvolatile ferroelectric memory to be accessed, the plurality of row repair programming group components operative to output respective signals indicative of the need to perform a row repair operation on some or all of a row based upon the received address information and information contained within the respective row repair programming group components;
an address match with enable bit set component operatively coupled to the row repair programming group components to receive the respective signals output by the row repair programming group components indicative of the need to perform a row repair operation on some or all of a row, the address match with enable bit set component operative to output a repair signal in response to the signals received from the row repair programming group components;
a dummy programming group component operative to receive the address information regarding an address of the nonvolatile ferroelectric memory to be accessed, and operative to output a dummy timing signal that gives signals output by the one or more row repair programming group components time to develop;
a timing controller component operative to output a row control signal;
a row redundancy switch component operative to receive the row control signal, the repair signal and the dummy timing signal; and
a primary nonvolatile ferroelectric memory array operative to receive one or more signals from the row redundancy switch component which facilitate a repair operation when necessary on some or all of a row, where the repair operation is performed utilizing one or more redundant rows within the primary nonvolatile ferroelectric memory array.

19. The system of claim 18, wherein the one or more redundant rows share a plategroup driver with a plategroup within the primary nonvolatile ferroelectric memory array.

20. A system configured to perform a column redundancy technique for a nonvolatile ferroelectric memory array, comprising:
a plurality of column repair programming group components operative to receive address information regarding an address of the nonvolatile ferroelectric memory to be accessed, the plurality of column repair programming group components operative to output respective signals indicative of the need to perform a column repair operation on some or all of a column based upon the received address information and information contained within the respective column repair programming group components;
a dummy programming group component operative to receive the address information regarding an address of the nonvolatile ferroelectric memory to be accessed, and operative to output a dummy timing signal that gives signals output by the one or more column repair programming group components time to develop;
an address match with enable bit set component operatively coupled to the column repair programming group components and the dummy programming group component to receive the respective signals output by the column repair programming group components indicative of the need to perform a column repair operation on some or all of a column and the dummy timing signal, the address match with enable bit set component operative to output one or more signals in response to the signals received from the column repair programming group components and the dummy programming group component; and
a primary nonvolatile ferroelectric memory array where the one or more signals output by the address match with enable bit set component facilitate a repair operation when necessary on some or all of a column, where the repair operation is performed utilizing one or more redundant columns within the primary nonvolatile ferroelectric memory array.

21. The system of claim 20, wherein the replacement operation comprises a shifting operation performed at a high level in a data path hierarchy.

22. A system configured to perform a high granularity redundancy technique for a nonvolatile ferroelectric memory array, comprising:
a plurality of high granularity repair programming group components operative to receive address information regarding an address of the nonvolatile ferroelectric memory to be accessed, the plurality of high granularity repair programming group components operative to output respective signals indicative of the need to perform a high granularity repair operation based upon the received address information and information contained within the respective high granularity repair programming group components;
a dummy programming group component operative to receive the address information regarding an address of the nonvolatile ferroelectric memory to be accessed, and operative to output a dummy timing signal that gives signals output by the one or more high granularity repair programming group components time to develop;
an address match with enable bit set component operatively coupled to the high granularity repair programming group components and the dummy programming group component to receive the respective signals output by the high granularity repair programming group components indicative of the need to perform a high granularity repair operation and the dummy timing signal, the address match with enable bit set component operative to output one or more signals in response to the signals received from the high granularity repair programming group components and the dummy programming group component; and
a primary nonvolatile ferroelectric memory array where the one or more signals output by the address match with enable bit set component facilitate a high granularity repair operation when necessary within the primary nonvolatile ferroelectric memory array.

23. A method of handling a fault in a nonvolatile ferroelectric memory array, comprising:
implementing a high granularity redundancy technique that performs a replacement operation when an address of the nonvolatile ferroelectric memory array corresponds to faulty row and faulty column information, and where the address pertains to a portion of the nonvolatile ferroelectric memory array that is less than a column high and less than a row wide; and
implementing a column redundancy technique that performs a replacement operation on a faulty aspect of a column of the nonvolatile ferroelectric memory array, where the replacement operation is performed with one or more redundant columns of the nonvolatile ferroelectric memory array.

24. The method of claim 23, wherein the high granularity redundancy technique and the column redundancy technique share one or more redundant columns of the nonvolatile ferroelectric memory array.

25. A method of repairing a faulty portion or grain of a nonvolatile ferroelectric memory array, where the array comprises R number of rows and C number of columns, R and C being positive integers, wherein the faulty grain comprises of a number of faulty row(s) fewer than R, and a number of faulty column(s) fewer than C, the method comprising:
replacing the faulty column(s) associated with the faulty grain with other column(s) when a bit within the faulty grain is accessed.

26. The method of claim 25 further comprising:
not performing a column replacement operation when a bit within a non faulty grain with different row number than that of the faulty grain and with a column number belonging to the faulty grain is accessed.

27. The method of claim 26, wherein the cells in a faulty grain are not contiguous.

28. The method of claim 27, wherein the replacement operation comprises a shifting operation performed on a shared input/output (IO) signal.

29. The method of claim 28, wherein the replacement operation is performed at a high level in a data path hierarchy of the nonvolatile ferroelectric memory.

30. The method of claim 29, wherein the replacement operation is performed between external DQ logic and global input/output (GIO) circuitry.

31. The method of claim 30, wherein 2 bits are replaced at a time.

32. The method of claim 31, wherein repair programming registers can replace any grain in an array but the programming registers are fewer in number than needed to replace all available repair elements.

33. The method of claim 32, further comprising:
loading failed addresses from ferroelectric nonvolatile memory into volatile repair programming registers at power up.

34. The method of claim 33, wherein a replacement operation is performed when an address match occurs within a repair programming group and an enable bit is set.

35. The method of claim 34, wherein a replacement operation is performed when an address match occurs within a repair programming group and two or more enable bits are set.

36. A method of performing a row redundancy technique for a nonvolatile ferroelectric memory array, comprising:
performing a replacement operation on a faulty aspect of a row of a nonvolatile ferroelectric memory array, where the replacement operation is performed with one or more redundant rows of the nonvolatile ferroelectric memory array, and where the one or more redundant rows share common programming registers;
wherein redundant rows share a plategroup with the primary nonvolatile ferroelectric memory array.

37. The method of claim 36, wherein the repair programming registers can replace any row in an array but the programming registers are fewer in number than needed to replace all available repair rows.
